(19) United States
(12) Patent Application Publication
(10) Pub. No.: US 2002/0136664 A1
(43) Pub. Date: Sep. 26, 2002

(54) Absolute humidity sensor

(76) Inventors: Don Hee Lee, Kyonggi-do (KR); Jong Uk Bu, Kyonggi-do (KR)

Correspondence Address: BIRCH STEWART KOLASCH & BIRCH, PO BOX 747, FALLS CHURCH, VA, 22040-0747, US

(21) Appl. No.: 09/913,333

(22) PCT Filed: Dec. 12, 2000
(86) PCT No.: PCT/KR00/01440

(30) Foreign Application Priority Data
Dec. 13, 1999 (KR) 1999-57196

(51) Int. Cl. B32B 27/12

(52) U.S. Cl. 422/98

(57) ABSTRACT

An absolute humidity sensor for a microwave oven is disclosed. The absolute humidity sensor includes a silicon substrate, a humidity sensing element formed on a substrate, for detecting humidity exposed to the air, having a variable resistance value depending on the amount of the humidity, a temperature compensating element formed on the semiconductor, for compensating for the resistance value of the humidity sensing element, and a passivation film covered on the temperature compensating element, for shielding the humidity exposed to the air so as not to vary the resistance value of the temperature compensating element. The humidity sensing element and the temperature compensating element include an insulating film formed on the substrate, a humidity sensing film formed on the insulating film, for absorbing the humidity, and an electrode formed below the humidity sensing film or over/below the humidity sensing film. A polyimide thin film, which absorbs the humidity greater than a ceramic based humidity sensing material, is used as a humidity sensing material, and a silicon wafer is used as a substrate. Thus, an absolute humidity sensor susceptible to humidity can be fabricated and at the same time the sensor is integrated using a silicon process to facilitate its mass production.

### TECHNICAL FIELD

The present invention relates to an absolute humidity sensor, and more particularly, to an absolute humidity sensor for a microwave oven.

### BACKGROUND ART

Generally, a humidity sensor is used for various purposes, for example, in a hygrometer, a humidity sensor for cooking of food in a microwave oven, and the like. Examples of currently used humidity sensors include a capacitance type humidity sensor, a relative humidity sensor, and an absolute humidity sensor. The capacitance type humidity sensor is based on variation of dielectric constants by hygroscopic property of an organic material such as polyimide. The relative humidity sensor is based on resistance variation of a semiconductor ceramic such as MgCr₂O₄. The absolute humidity sensor is based on a ceramic thermistor.

Of the humidity sensors, the absolute humidity sensor based on two thermistors is widely used as a humidity sensor for cooking of food in a microwave oven.

The absolute humidity sensor has an advantage in that it can stably detect the humidity because it is not susceptible to variation of a peripheral temperature.

The principles of sensing humidity of the absolute humidity sensor in the microwave oven are based on resistance variation by temperature variation of a thermistor as vapor generated from food during cooking of food absorbs heat of the thermistor.

FIG. 1 shows a structure of a background art absolute humidity sensor. Referring to FIG. 1, two ceramic thermistors 1 and 2 coated with a passivation film such as a glass film are floating by being connected to a support pin 4 by a precious metal conductor 3 such as platinum. The ceramic thermistors 1 and 2 are packaged by a metal shield case 5 that isolates the two thermistors 1 and 2 from each other.

The thermistor 1 is exposed to the air to allow vapor to be in contact with a surface of the thermistor 1 by means of a fine hole of the metal shield case 5. The thermistor 1 is used as a sensing element. The other thermistor 2 is sealed in a dry N₂ by the metal shield case 5 so as not to be in contact with the vapor. The thermistor 2 is used as a reference element.

Therefore, if a bridge circuit consists of the two thermistors 1 and 2 and an external resistor, the vapor generated from food during cooking of food absorbs heat of the thermistor 1 exposed to the air. Thus, resistance variation occurs in only the exposed thermistor 1. In this case, output variation occurs due to a bias voltage, thereby detecting the humidity.

Since the background art humidity sensor uses an element as a ceramic thermistor, heat capacity is great and thus sensitivity is low. Also, response time is slow and the size of the sensor becomes greater.

Furthermore, the thermistor element is floating using the conductor 3 and the support pin 4 as shown in FIG. 1, and the conductor 3 and the pin 4 are spot-welded. For assembly, the reference element 2 should be sealed in a dry N₂. For this reason, the fabrication process steps are complicate and the number of the process steps increases. Also, the cost is expensive and mass production is disadvantageous.

### DISCLOSURE OF THE INVENTION

Accordingly, the present invention is directed to an absolute humidity sensor that substantially obviates one or more of the problems due to limitations and disadvantages of the background art.

An object of the present invention is to provide an absolute humidity sensor having excellent humidity hygroscopic property.

Another object of the present invention is to provide an absolute humidity sensor having simple process steps to facilitate mass production.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an absolute humidity sensor according to the present invention includes a silicon substrate, a humidity sensing element formed on a substrate, for detecting humidity exposed to the air, having a variable resistance value depending on the amount of the humidity, a temperature compensating element formed on the semiconductor, for compensating for the resistance value of the humidity sensing element, and a passivation film covered on the temperature compensating element, for shielding the humidity exposed to the air so as not to vary the resistance value of the temperature compensating element.

In the preferred embodiment of the present invention, the humidity sensing element and the temperature compensating element include an insulating film formed on the substrate, a humidity sensing film formed on the insulating film, for absorbing the humidity, and an electrode formed below the humidity sensing film or over/below the humidity sensing film.

The insulating film and the passivation film are formed of any one of SiO₂, Si₃N₄, and SiOₓN_{y}. The humidity sensing film is formed of polyimide annealed at a temperature of 200˜300° C. The electrode uses a comb electrode.

The absolute humidity sensor according to the present invention further includes a printed circuit board joined with a lower portion of the silicon substrate, a wire which electrically connects electrodes of the humidity sensing element and the temperature compensating element with electrodes of the printed circuit board, and a metal shield case formed over the printed circuit board to cover an entire surface of the printed circuit board including the humidity sensing element and the temperature compensating element.

In the preferred embodiment of the present invention, a polyimide thin film, which absorbs the humidity greater than a ceramic based humidity sensing material, is used as a humidity sensing material, and a silicon wafer is used as a substrate. Thus, an absolute humidity sensor susceptible to humidity can be fabricated and at the same time the sensor is integrated using a silicon process to facilitate its mass production.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a structural sectional view showing a background art of an absolute humidity sensor;

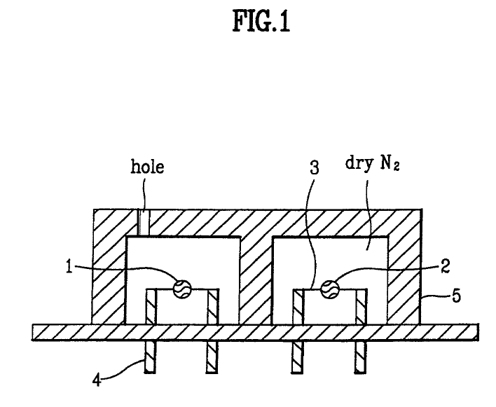

FIGS. 2a and 2b are structural perspective views showing a resistance type absolute humidity sensor according to the present invention;

FIGS. 3a and 3b are structural perspective views showing a capacitance type absolute humidity sensor according to the present invention;

FIGS. 4a and 4b show a structure of an absolute humidity sensor package according to the present invention; and

FIG. 5 is a circuit diagram for detecting the humidity based on the resistance type absolute humidity sensor according to the present invention.

### BEST MODE FOR CARRYING OUT THE INVENTION

Reference will now be made in detail to the preferred embodiments of the present invention, examples of which are illustrated in the accompanying drawings.

### First Embodiment

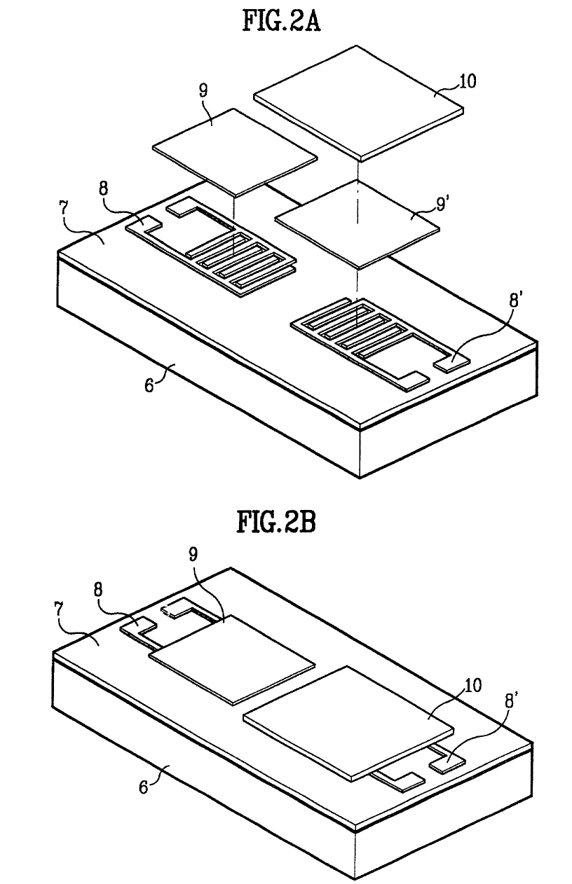

FIGS. 2a and 2b are structural perspective views showing a resistance type absolute humidity sensor according to the present invention.

As shown in FIG. 2a, an insulating film 7 of SiO₂, Si₃N₄, or SiOₓN_{y} is formed on a silicon substrate 6. A metal film such as Al or Pt is deposited on the insulating film 7 and then patterned to form a pair of electrodes 8 and 8′ in a comb shape.

Afterwards, a polyimide thin film is spin-coated on the electrode and then patterned to form a humidity sensing film 9 for a humidity sensing element and a humidity sensing film 9′ for a temperature compensating element.

The polyimide is imidized at a temperature of about 200° C. or greater. The polyimide has a thermal decomposition temperature of about 450˜500° C. Accordingly, the polyimide has excellent thermal stability.

Also, the polyimide has a hygroscopic property as follows.

An equilibrium value of an aqueous molecule absorbed into the polyimide at a room temperature under the ambient of a relative humidity ambient of 80% is about 2.3 wt %. The polyimide absorbs humidity more than a ceramic based humidity sensing material. Moreover, a diffusion coefficient of the aqueous molecule within a polyimide thin film is approximately 5×10⁻⁹cm²/sec at a room temperature. Accordingly, high response time can be obtained.

The polyimide thin film has a compact film tissue when annealing is performed at a high temperature of about 300° C. or greater. In this case, it is difficult to propagate the humidity into the film. To use the polyimide thin film as a humidity sensing element, the annealing process is preferably performed at a temperature between 200° C. and 300° C. to obtain high hygroscopic ratio of the polyimide film.

After the humidity sensing films 9 and 9′ are formed, a ceramic thin film such as SiO₂, Si₃N₄, and SiOₓN_{y} is deposited on the humidity sensing film 9′ for a temperature compensating element and then patterned, so that the humidity is not propagated into the humidity sensing film 9′. Thus, a passivation film 10 is formed.

In the resistance type absolute humidity sensor fabricated as above, it is noted that, as shown in FIG. 2b, the humidity sensing element and the temperature compensating element are formed on the same silicon substrate 6.

### Second Embodiment

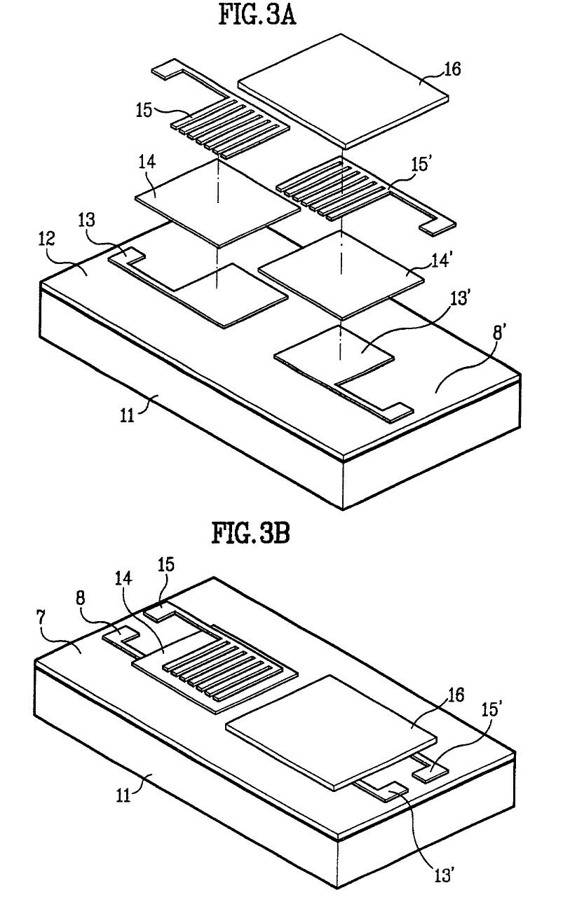

FIGS. 3a and 3b are structural perspective views showing a capacitance type absolute humidity sensor according to the present invention.

As shown in FIG. 3a, an insulating film 12 of SiO₂, Si₃N₄, or SiOₓN_{y} is formed on a silicon substrate 11. A metal film such as Al or Pt is deposited on the insulating film 12 and then patterned to form a lower electrode 13 for a humidity sensing element and a lower electrode 13′ for a temperature compensating element.

Afterwards, a polyimide thin film is spin-coated on the lower electrodes 13 and 13′ and then patterned to form a humidity sensing film 14 for a humidity sensing element and a humidity sensing film 14′ for a temperature compensating element. Subsequently, an annealing process is performed at a temperature between 200° C. and 300° C.

The metal film having the same material as that of the lower electrodes 13 and 13′ is deposited on the polyimide humidity sensing films 14 and 14′ and then patterned to form an upper electrode 15 for a humidity sensing element and an upper electrode 15′ for a temperature compensating element in a comb shape. Thus, a parallel capacitor structure is formed in such a manner that the polyimide humidity sensing film is formed between the upper and lower electrodes.

Unlike the lower electrodes 13 and 13′, the upper electrodes 15 and 15′ are formed in a comb shape to allow an aqueous molecule to smoothly pass through the polyimide humidity sensing film, thereby partially exposing the polyimide thin film.

Accordingly, the vapor is directly in contact with the polyimide humidity sensing film exposed between the upper electrodes, so as to be propagated into the thin film.

The polyimide has a relative dielectric constant of 3 to 4 at a room temperature. Also, the polyimide has a dissipation factor value of 0.001˜0.003 at the frequency of 1 kHz. Accordingly, the polyimide has a stable dielectric property.

In the present invention, since the polyimide humidity sensing film acts as a dielectric of a capacitor, dielectric mixtures having different dielectric constants are formed within the polyimide thin film if the aqueous molecule having a relative dielectric constant of 80 is propagated into the polyimide thin film.

Thus, the relative dielectric constant of the dielectric mixtures is varied depending on variation of the peripheral humidity, so that the humidity variation can be detected.

Finally, a ceramic thin film such as SiO₂, Si₃N₄, and SiOₓN_{y} is deposited on the humidity sensing film 14′ for a temperature compensating element and the upper electrode 15′ and then patterned, so that the humidity is not propagated into the humidity sensing film 14′. Thus, a passivation film 16 is formed.

In the capacitance type absolute humidity sensor fabricated as above, it is noted that, as shown in FIG. 3b, the humidity sensing element and the temperature compensating element are formed on the same silicon substrate 11.

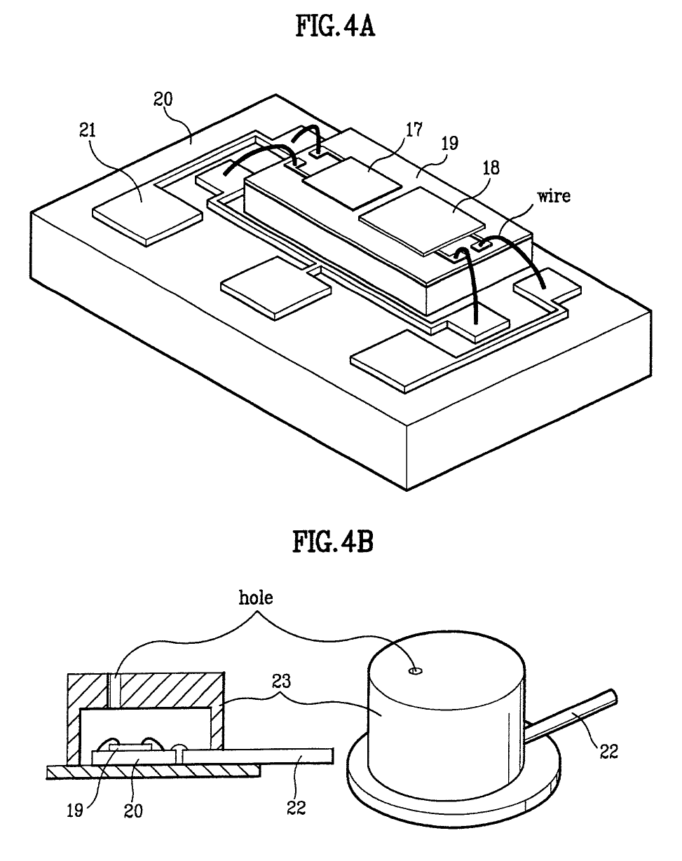

FIGS. 4a and 4b show a package structure of an absolute humidity sensor according to the present invention, in which one example of the resistance type absolute according to the first embodiment of the present invention is shown.

As shown in FIG. 4a, an absolute humidity sensor element 19 provided with a humidity sensing element 18 and a temperature compensating element 18 as fabricated by the method of the first embodiment is joined with a printed circuit board 20. Electrodes 8 and 8′ of the elements are wire-bonded to an electrode 21 of the printed circuit board 20. Afterwards, as shown in FIG. 4b, a shield wire 22 is connected to the printed circuit board 20. The shield wire 22 and the printed circuit board 20 are sealed with a metal shield case 23 having a hole to propagate the humidity thereinto. Thus, the package of the absolute humidity sensor is completed.

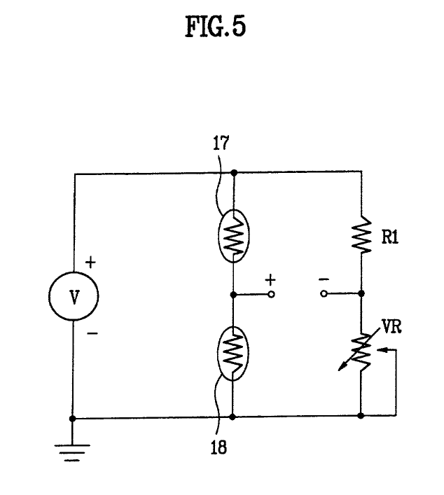

FIG. 5 is a circuit diagram for detecting variation of the peripheral humidity based on the resistance type absolute humidity sensor according to the present invention. The circuit for detecting variation of the peripheral humidity includes a bridge circuit and a power source V applied to the bridge circuit. The bridge circuit consists of a humidity sensing element 17, a temperature compensating element 18, a fixed resistor R1, and a variable resistor VR.

As an example, a method for detecting variation of the humidity by the water vapor generated from food during cooking of food in a microwave oven using the absolute humidity sensor and the above circuit will be described below.

First, if the food is heated in the microwave oven, the water vapor is generated. The generated water vapor is propagated into the metal shield case 23 through the hole formed therein. Thus, the water vapor is in contact with the humidity sensing element 17 and the temperature compensating element 18.

At this time, the humidity sensing element 17 has a varied resistance as the humidity is absorbed in the polyimide. However, the temperature compensating element 18 does not have a varied resistance as the humidity is not absorbed in the polyimide due to the passivation film.

The resistance variation of the humidity sensing element 17 causes output variation of the bridge circuit, thereby detecting the humidity variation.

Accordingly, the humidity variation around the sensor can easily be detected by the absolute humidity sensor and the above circuit. The water vapor generated from the food due to heat during cooking of food in a cooking machine such as a microwave oven is detected to apply for automatic cooking of food.

### Industrial Applicability

As aforementioned, the absolute humidity sensor according to the present invention has the following advantages.

The polyimide thin film, which absorbs the humidity greater than a ceramic based humidity sensing material, is used as a humidity sensing material, and a silicon wafer is used as a substrate. Thus, an absolute humidity sensor susceptible to humidity can be fabricated and at the same time the sensor can be integrated using a silicon process. This simplifies the package process and facilitates mass production of the sensor.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An absolute humidity sensor comprising:
a silicon substrate;
a humidity sensing element formed on a substrate, for detecting humidity exposed to the air, having a variable resistance value depending on the amount of the detected humidity;
a temperature compensating element formed on the semiconductor, for compensating for the resistance value of the humidity sensing element; and
a passivation film covered on the temperature compensating element, for shielding the humidity exposed to the air so as not to vary the resistance value of the temperature compensating element.

2. The absolute humidity sensor of claim 1, wherein the humidity sensing element and the temperature compensating element include:
an insulating film formed on the substrate;
a humidity sensing film formed on the insulating film, for absorbing the humidity; and
an electrode formed below the humidity sensing film or over/below the humidity sensing film.

3. The absolute humidity sensor of claim 2, wherein the insulating film is formed of any one of SiO₂, Si₃N₄, and SiOₓN_{y}.

4. The absolute humidity sensor of claim 2, wherein the humidity sensing film is formed of polyimide.

5. The absolute humidity sensor of claim 2, wherein the electrode has a comb shape.

6. The absolute humidity sensor of claim 2, wherein the electrode formed only over the humidity sensing film has a comb shape.

7. The absolute humidity sensor of claim 1, wherein the passivation film is formed of any one of SiO₂, Si₃N₄, and SiOₓN_{y}.

8. The absolute humidity sensor of claim 1, further comprising:
a printed circuit board joined with a lower portion of the silicon substrate;
a wire for electrically connecting electrodes of the humidity sensing element and the temperature compensating element with electrodes of the printed circuit board; and
a metal shield case formed over the printed circuit board to cover an entire surface of the printed circuit board including the humidity sensing element and the temperature compensating element.

9. The absolute humidity sensor of claim 8, wherein the metal shield case has a hole for propagation of external humidity.
